(19) United States
(12) Patent Application Publication
(10) Pub. No.: US 2026/0019111 A1
(43) Pub. Date: Jan. 15, 2026

(54) REFLECTION TIME-ANGLE CODING OF AN INCIDENT ANGLE DURING RADIO SENSING OPERATIONS

(71) Applicant: LENOVO (SINGAPORE) PTE. LTD., Singapore (SG)

(72) Inventors: Seyedomid TAGHIZADEH MOTLAGH, Oberursel (DE); Ali Ramadan ALI, Kraiburg am Inn (DE); Sher Ali CHEEMA, Ilmenau (DE); Soumya Somasekharan NAMBIAR, Aachen (DE)

(21) Appl. No.: 19/112,459

(22) PCT Filed: Oct. 5, 2023
(86) PCT No.: PCT/IB2023/060022

§ 371 Date: Mar. 17, 2025

Related U.S. Application Data
(60) Provisional application No. 63/378,469, filed on Oct. 5, 2022.

(51) Int. Cl. H04B 7/04

(52) U.S. Cl. CPC H04B 7/04013

(57) ABSTRACT

Various aspects of the present disclosure relate to performing radio sensing operations using a reconfigurable intelligent surface (RIS). For example, a sensing controller device, which can be part of a network device (e.g., a network entity or UE) sends encoding information associated with sensing signals transmitted to a target area by a transmitting node. A controller associated with the RIS (e.g., a RIS controller) receives the encoding information and modifies or adjusts reflection characteristics for waves or signals incident on the RIS and reflected by the RIS to one or more sensing nodes. Thus, the RIS controller receives the encoding information for waves or signals that reflect off objects within the target area to the RIS, and utilizes the encoding information (e.g., incident angle or time information) to adjust the reflection characteristics and provide the information to the sensing node, which performs measurements based on the sensing signals.

### CROSS REFERENCE TO RELATED APPLICATIONS

This application claims priority to U.S. Provisional Patent Application No. 63/378,469, filed on Oct. 5, 2022, entitled REFLECTION TIME-ANGLE CODING OF AN INCIDENT ANGLE DURING RADION SENSING OPERATIONS, which is hereby incorporated by reference in its entirety.

### TECHNICAL FIELD

The present disclosure relates to wireless communications, and more specifically to performing radio sensing operations within a wireless communications system.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system, via the various communication devices, can perform radio sensing to improve network performance and/or serve various use cases or associated services. Radio sensing operates to obtain environment information by using radio-frequency (RF) signaling to detect objects or areas within an environment, such as a physical location or environment that includes a UE or other user devices.

For example, a radio sensing mechanism, scheme, or technique can include: transmission of a sensing signal (e.g., sensing RS) from a sensing Tx node (e.g., a network entity or UE), reception of reflections/echoes of the transmitted sensing signal from the environment by a sensing Rx node (e.g., a network entity or UE), and/or processing of the received reflections to infer information from the environment or objects within the environment.

### SUMMARY

The present disclosure relates to methods, apparatuses, and systems that support performing radio sensing operations using a reconfigurable intelligent surface (RIS). For example, a sensing controller device, which can be part of a network device (e.g., a network entity or UE) sends encoding information associated with sensing signals transmitted to a target area by a transmitting node.

A controller associated with the RIS (e.g., a RIS controller) receives the encoding information and modifies or adjusts reflection characteristics for waves or signals incident on the RIS and reflected by the RIS to one or more sensing nodes. Thus, the RIS controller receives the encoding information for waves or signals that reflect off objects within the target area to the RIS, and utilizes the encoding information (e.g., incident angle or time information) to adjust the reflection characteristics and provide the information to the sensing node, which performs measurements based on the sensing signals.

Some implementations of the method and apparatuses described herein may further include an apparatus, comprising a processor and a memory coupled with the processor, the processor configured to cause the apparatus to transmit, to a first device, a first configuration for transmitting a sensing signal to a target area and transmit, to a second device, a second configuration for reflecting a set of incident waves to a set of sensing devices based at least in part on the second configuration.

In some implementations of the method and apparatuses described herein, the apparatus comprises a first UE or a first network entity, the first device comprises a second UE or a second network entity, the second device comprises a RIS entity comprising a RIS controller or a set of RIS entities, or both, and the set of sensing devices comprises a set of UEs or a set of network entities, or both.

In some implementations of the method and apparatuses described herein, the processor is further configured to cause the apparatus to transmit the first configuration to the set of sensing devices and transmit a third configuration to the set of sensing devices, wherein the third configuration includes a configuration of a sensing measurement based on the sensing signal having the first configuration.

In some implementations of the method and apparatuses described herein, the first configuration includes a waveform type of a set of waveform-defining parameters associated with the sensing signal, a set of resources over which the sensing signal is transmitted, a transmission beam or radiation pattern over which the sensing signal is transmitted, a transmit power over which the sensing signal is transmitted, or a sequence generation and physical resource mapping type based on which the sensing signal is generated.

In some implementations of the method and apparatuses described herein, the second configuration includes: a mapping of incident angles for the one or more incident waves to reflection angles for the reflections of the one or more incident waves to the set of sensing devices, a time pattern associated to mappings of incident angles to reflection angles, or a combination thereof.

In some implementations of the method and apparatuses described herein, the second device determines at least a portion of the reflection configuration and transmits the portion of the reflection configuration to the sensing controller device.

In some implementations of the method and apparatuses described herein, the second configuration further includes one or more reflection rules, including: an indication of at least one incident angle or incident angular segment towards the second device and at least one reflection angle or reflection angular segment from the second device such that there is no incident wave reflection towards the at least one reflection angle/angular segment from outside of the incident angle/angular segments, an indication of at least one incident angle or incident angular segment towards the second device and at least one reflection angle or reflection angular segment from the second device such that there is no incident wave reflection towards the at least one reflection angle/angular segment from the incident angle/angular segments, an indication of one or more time patterns associated with the one or more reflection rules, an indication of one or more leakage levels for the second device, or combinations thereof.

In some implementations of the method and apparatuses described herein, the second configuration further includes one or more reflection rules, including: an indication of at least one incident angle or incident angular segment towards the second device and at least one reflection angle or reflection angular segment from the second device such that there is no incident wave reflection towards the angle outside of the at least one reflection angle or reflection angular segment from the incident angle or incident angular segments, an indication of at least one incident angle or incident angular segment towards the second device and at least one reflection angle or reflection angular segment from the second device such that there is no incident wave reflection towards the reflection angle outside of the least one reflection angle or reflection angular segment from the incident angles outside of the incident angle or incident angular segments, an indication of one or more time patterns associated with the one or more reflection rules, an indication of one or more leakage levels for the second device, or combinations thereof.

In some implementations of the method and apparatuses described herein, the mapping of incident angles for the set of incident waves to reflection angles for the reflections of the set of incident waves to the set of sensing devices includes an indication of one or more desired energy levels.

In some implementations of the method and apparatuses described herein, the second configuration is based, at least in part, on: channel strength indicators (CSIs) for a line-of-sight (LOS) propagation path from the second device to the set of sensing devices, CSIs for a non-line-of-sight (NLOS) propagation path from the second device to the set of sensing devices, CSIs for a LOS propagation path from the second device to the first device, CSIs for an NLOS propagation path from the second device to the first device, or combinations thereof.

In some implementations of the method and apparatuses described herein, the mapping of incident angles for the one or more incident waves at the second device to reflection angles for the reflections of the one or more incident waves is according to: one or more mappings of transmission time symbols or transmission beams/angles of the first device to indicated angles of reflection or angular segments of reflection at the second device, one or more mappings of reception time symbols, the set of one or multiple sensing devices, the reception angle or angular segment of arrival at the set of sensing devices, or a combination thereof, to indicated angles of incidence or angular segments of incidence at the second device, or a combination thereof.

In some implementations of the method and apparatuses described herein, the one or more mappings of reception time symbols, the set of one or multiple sensing devices, the reception angle or angular segment of arrival at the set of sensing devices, or a combination thereof, to indicated angles of incidence or angular segments of incidence at the second device includes: an individual mapping of reception time symbols, the set of sensing devices, the reception angle or angular segment of arrival at the set of sensing devices, or a combination thereof, to indicated angles of incidence or angular segments of incidence at the second device, and simultaneous mapping of the reception time symbols, the set of sensing devices, the reception beam, angle or angular segment of arrival at the set of sensing devices, or a combination thereof, to one or more single indicated angles of incidence or angular segments of incidence at the second device; a simultaneous mapping of multiple of reception time symbols, sensing devices, the reception beams, angle or angular segments of arrival at the set of sensing devices, or a combination thereof, to indicated angles of incidence or angular segments of incidence at the second device, or a combination thereof.

In some implementations of the method and apparatuses described herein, the one or more mappings of transmission time symbols, the transmission beams/angles or angular segments of departure at the first device, or a combination thereof, to indicated angles of reflection or angular segments of reflection at the second device includes: an individual mapping of transmission time symbols, the transmission angle or angular segment of departure at the first device, or a combination thereof, to indicated angles of reflection or angular segments of reflection at the second device, a simultaneous mapping of transmission time symbols, the transmission angle or angular segment of departure at the first device, or a combination thereof, to plurality of indicated angles of reflection or angular segments of reflection at the second device, a simultaneous mapping of multiple of transmission time symbols, the transmission angle or angular segment of departure at the first device, or a combination thereof, to indicated angles of reflection or angular segments of reflection at the second device, or a combination thereof.

In some implementations of the method and apparatuses described herein, the second configuration is indicated by: a 1-D array of binary values, a 2-D matrix of binary values, a bitmap, a 2-D matrix of real positive values, or a quantized or compressed version of the 1-D array, the 2-D matrices, or the bitmap.

In some implementations of the method and apparatuses described herein, the second device performs the mapping, at least in part, on a pre-defined index of angular segments in an azimuth direction, an elevation direction, or a joint azimuth and elevation direction.

In some implementations of the method and apparatuses described herein, the second device performs the mapping, at least in part, on a first function, a second function, and an ordering rule, wherein: an angular segment corresponding to a first value is obtained from the first function on an angular segment of reflection, an angular segment corresponding to a second value is obtained from the second function, and the ordering rule pairs the angular segments.

In some implementations of the method and apparatuses described herein, the processor is further configured to cause the apparatus to transmit a fourth configuration to the set of sensing devices, including, for each sensing device of the set of sensing devices: a determination of one or multiple angle or angular segment of incidence at the second device, a determination of an angle or angular segment of reflection for each sensing signal transmitted to the second device, an indication of one or more angles of reception at the set of sensing devices, an indication of a mapping of reception time symbols, the set of one or multiple sensing devices, the reception angle or angular segment of arrival at the set of sensing devices, or a combination thereof, to indicated angles of incidence or angular segments of incidence at the second device, an indication of mapping of transmission time symbols and/or transmission beams/angles of the first device to indicated angles of reflection or angular segments of reflection at the second device, an indication of one or more angles or angular segments of incidence for the second device or one or more angles or angular segments of reflection for the second device with respect to an angle or angular segment of incidence for each wave of the set of incident waves received by the second device, an indication of one or more time patterns with respect to the one or more angles or angular segments of incidence for the second device or one or more angles or angular segments of reflection for the second device, a location of the first device, a location of the second device, an indication of one or more information types to be generated in response to sensing measurements performed by the set of sensing devices, an indication of one or more quality of service (QOS) parameters for the one or more information types, an indication of conditions that determine the one or more information types or one or more QoS parameters, or combinations thereof.

In some implementations of the method and apparatuses described herein, the processor is further configured to cause the apparatus to receive a radio sensing task, wherein the radio sensing task includes: information identifying the target area in a coordinate system format available to the first device, information identifying features of an object of interest to be sensed within the target area, or information identifying a quality of service (QOS) for sensing, receive, from the second device capability information for the second device, receive radio sensing capability information for the apparatus, determine a radio sensing scenario, determine the first configuration or the second configuration, or combinations thereof.

In some implementations of the method and apparatuses described herein, the capability information for the second device includes: a supported angular range of incidence based on a global or local coordinate system, a supported angular range of reflection based on a global or local coordinate system, a supported angular resolution, a number of adjustable reflection elements of the second device, a number of bits describing phase adjustment resolution performed by the second device, information identifying additive noise variance at the second device, information identifying multiplicative noise variance at the second device, information identifying a passive or active reflective element capability of the second device, a reflector surface size or aperture size for the second device, a reflector surface shape of the second device, a reflector surface angle or orientation of the second device, a reflector surface coverage distance for the second device, an operating frequency band of the second device, or combinations thereof.

In some implementations of the method and apparatuses described herein, the apparatus is a sensing controller that is part of a network entity, a UE a repeater device, or a core network device.

Some implementations of the method and apparatuses described herein may further include a method comprising: transmitting, to a first device, a first configuration for transmitting a sensing signal to a target area and transmitting, to a second device, a second configuration for reflecting a set of incident waves to a set of sensing devices based at least in part on the second configuration.

In some implementations of the method and apparatuses described herein, the first device comprises a UE or a network entity, the second device comprises a RIS entity comprising a RIS controller or a set of RIS entities, or both, and the set of sensing devices comprises a set of UEs or a set of network entities, or both.

In some implementations of the method and apparatuses described herein, the method further comprises transmitting, to the set of sensing devices, a third configuration that includes a configuration of a sensing measurement based on the sensing signal having the first configuration.

In some implementations of the method and apparatuses described herein, the first configuration includes: a waveform type of a set of waveform-defining parameters associated with the sensing signal, a set of resources over which the sensing signal is transmitted, a transmission beam or radiation pattern over which the sensing signal is transmitted, a transmit power over which the sensing signal is transmitted, or a sequence generation and physical resource mapping type based on which the sensing signal is generated.

In some implementations of the method and apparatuses described herein, the second configuration includes: a mapping of incident angles for the one or more incident waves to reflection angles for the reflections of the one or more incident waves to the set of sensing devices, a time pattern associated to mappings of incident angles to reflection angles, or a combination thereof.

Some implementations of the method and apparatuses described herein may further include a RIS controller associated with a RIS, the RIS controller comprising a processor and a memory coupled with the processor, the processor configured to receive a configuration associated with reflecting one or more sensing signals reflected by the RIS from a transmitting device and adjust RIS reflection characteristics of the RIS based on the received configuration.

Some implementations of the method and apparatuses described herein may further include a method performed by a RIS controller associated with a RIS, the method comprising receiving a configuration associated with reflecting one or more sensing signals reflected by the RIS from a transmitting device and adjusting one or more RIS reflection characteristics of the RIS based on the received configuration.

Some implementations of the method and apparatuses described herein may further include a system, comprising a sensing controller device that transmits a signal configuration for a sensing signal to a transmitting device and transmits a reflection configuration to a RIS, wherein the RIS is configured to reflect the sensing signal to a sensing device, and RIS controller that adjusts RIS reflection characteristics of the RIS based on the received reflection configuration.

In some implementations of the method and apparatuses described herein, the sensing device receives a sensing configuration from the sensing controller device and performs sensing measurements for one or more sensing signals received from the RIS using the sensing configuration.

In some implementations of the method and apparatuses described herein, the sensing device receives a reporting configuration for generation and transmission of a report based on the performed sensing measurements and generates a sensing measurement report based on the reporting configuration.

In some implementations of the method and apparatuses described herein, the reporting configuration includes: a set of time, frequency and beam resources for transmission of the report, a criterion for transmission of the report; or a type of information included in the report.

### BRIEF DESCRIPTION OF THE DRAWINGS

FIG. 1 illustrates an example of a wireless communications system that supports performing radio sensing operations in accordance with aspects of the present disclosure.

FIG. 2 illustrates an example of a diagram that supports implementation of a reconfigurable intelligent surface (RIS) during a radio sensing operation in accordance with aspects of the present disclosure.

FIG. 3 illustrates an example of a diagram that supports encoding angle information of incidence waves during radio sending operations in accordance with aspects of the present disclosure.

FIG. 4 illustrates an example of a diagram that supports relating incident angles or angular segments to reflection angles or angular segments in accordance with aspects of the present disclosure.

FIG. 5 illustrates an example of a diagram that supports encoding time information of incidence angles during radio sending operations in accordance with aspects of the present disclosure.

FIG. 6 illustrates an example of a diagram that supports relating incident angles or angular segments to reflection times in accordance with aspects of the present disclosure.

FIG. 7 illustrates an example of a diagram that supports relating incident angles or angular segments to reflection times and reflection angles in accordance with aspects of the present disclosure.

FIG. 8 illustrates an example of a diagram that supports radiating sensing signals to a RIS during radio sending operations in accordance with aspects of the present disclosure.

FIG. 9 illustrates an example of a block diagram of a device that supports encoding time and/or angle information of incidence angles during radio sending operations in accordance with aspects of the present disclosure.

FIG. 10 illustrates a flowchart of a method that supports transmitting incidence angle information during radio sensing operations in accordance with aspects of the present disclosure.

FIG. 11 illustrates a flowchart of a method that supports a RIS controller modifying reflection characteristics of a RIS during radio sensing operations in in accordance with aspects of the present disclosure.

### DETAILED DESCRIPTION

As described herein, a RIS can collect and/or control radio wave propagations, such as sensing signals or waves utilized during RF-based environment sensing. For example, segments of the RIS can monitor reflections from a target area of interest and/or illuminate the target area or interest.

However, in some implementations, certain information about a sensing operation, such as angular information from a target reflection point, can be lost because a sensing node receives a sensing signal from the RIS and not from the target area of interest (or one or more detected objects within the target area of interest). For example, in some cases, when multiple waves reflect off objects from the target area, the sensing node cannot disambiguate the waves because the angular information is unknown to the sensing node. Such ambiguity can lead to a degradation of sensing performance, among other drawbacks.

Thus, the radio sensing operation can include or maintain angular information for wave reflections between transmitting nodes and sensing nodes. In some embodiments, the radio sending operation can configure reflections at the RIS, such that the sensing nodes receive the angular information.

For example, a sensing controller can transmit encoding information or configuration information to the RIS, such as in a reflection configuration. The sending controller can encode (e.g., as a defined and/or configured codebook): (1) incident wave angles towards a RIS as an angular pattern of reflection from the RIS towards one or more sensing nodes, (2) incident wave angles towards the RIS as a time pattern of reflection from the RIS towards the one or more sensing nodes, (3) wave reflection angles from the RIS as an angular incident pattern and/or as a time pattern for wave incidence/reflection at the RIS, where the reflection wave angle from the RIS is determined based on the incident wave time-angle pattern towards the RIS, and so on.

Thus, in various embodiments, a radio sensing operation can utilize a RIS during sensing operations without losing angular information associated with the sensing signals, enabling the radio sensing operation to expand its capacity to measure a target area using multiple sensing signals as well as expand the size of the target area by using a RIS as an intermediary between Tx nodes and Rx nodes, among other benefits.

Aspects of the present disclosure are described in the context of a wireless communications system. Aspects of the present disclosure are further illustrated and described with reference to device diagrams and flowcharts.

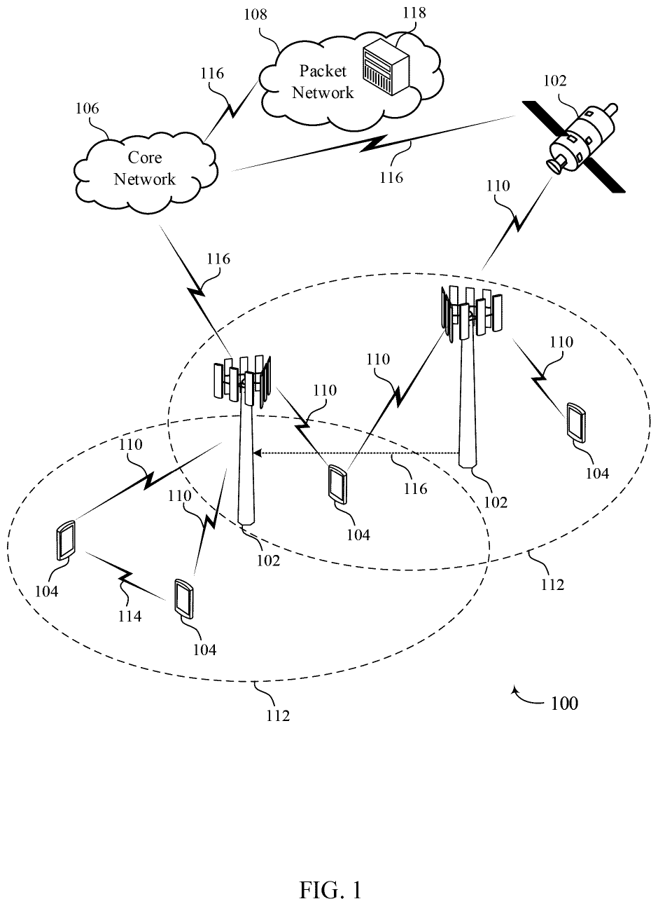

FIG. 1 illustrates an example of a wireless communications system 100 that supports performing radio sensing operations in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUsor RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, (=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. # Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHZ), FR3 (7.125 GHz-24.25 GHz), FR4 (52.6 GHZ-114.25 GHZ), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FRI may be associated with a first numerology (e.g., p=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the wireless communications system 100 supports the implementation of radio sensing operations performed by different nodes of the system 100, such as the base stations 102 and/or the UEs 104.

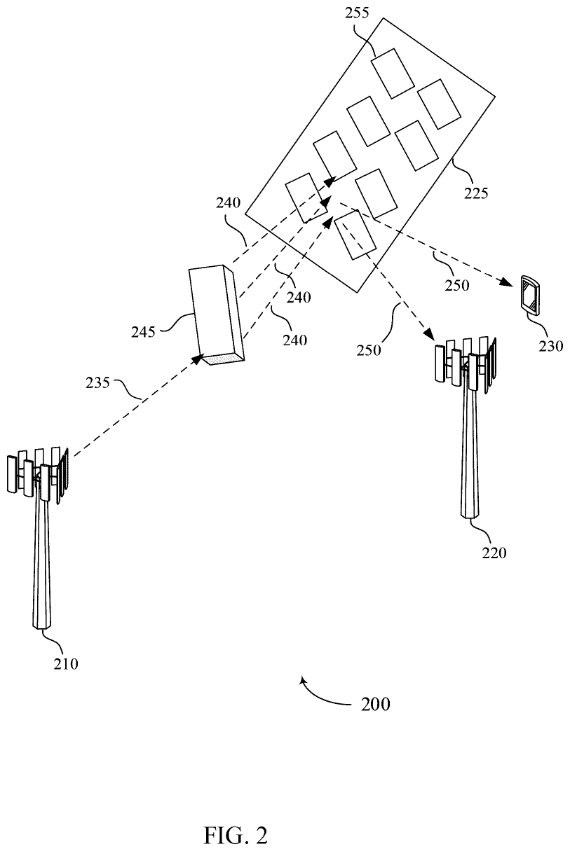

FIG. 2 illustrates an example of a diagram 200 that supports implementation of a reconfigurable intelligent surface (RIS) during a radio sensing operation in accordance with aspects of the present disclosure. As depicted, radio sensing occurs between a base station or other network entity 210 acting as a Tx node (e.g., a transmitting device), and multiple sensing devices, such as another base station 220 and a UE 230 acting as Rx nodes.

As a first example of the radio sensing operation, the base station 210 transmits a sensing RS 235, which reflects off an object 245 as a wave incident to a RIS 225, such as one or more incident waves 240 that are received by the RIS 225. The incident waves 240 are reflected by the RIS 225 as reflection waves 250, which are received by one or more network devices, such as the base station 220 or the UE 230.

As described herein, the RIS 225, which can also be an intelligent reflecting surface (IRS) or large intelligent surface (LAS), can enhance the capacity and/or coverage of a wireless network. In some cases, the RIS 225 adjusts the phase and/or amplitude of RIS elements or segments 255, which reconfigures a propagation environment within the wireless network by modifying incident radio waves (e.g., reflecting them from the RIS to other devices, elements, or nodes).

Further, although the disclosure often refers controlling the RIS 225 to enable sensing, other similar devices, such as network-controlled repeaters or any relay/repeater/IAB node can perform the reflections during the sensing operations described herein.

In some cases, the network can indicate the sensing RS 235 to other (non-network) nodes or a subset of the UE nodes via Radio Resource Control (RRC) signaling, Physical Downlink Shared Channel (PDSCH) or Physical Downlink Control Channel (PDCCH)/Downlink Control Element (DCI) signaling or a group-common DCI.

For example, the network can signal the other resources via group-common DCI when the sensing RS 235 occupies resources similar to other physical channels, and hence, the indication of the sensing RS 235 is used to suppress the received RS 240 by nodes other than sensing Rx nodes, or used as an indication of sensing-dedicated resources where some of the physical channels are not be present/interfered with, or to mute transmissions taking place at the same resource to protect the sensing operation, for the purpose of interference measurements from the sensing Tx towards the UE nodes or other network devices, and/or where the sensing RS 235 is indicated to be re-used for other purposes (e.g., as an RS to track some CSI/environment information) by the UE devices.

In some cases, the assignment of the sensing RS 235 includes implicit information on the utilized waveform parameters (e.g., CP/guard-band length for the UE nodes, the type of the required sensing processing and reporting procedure, and so on).

As another example of the radio sensing operation 200, the base station 210 transmits and receives the sensing RS 235 (e.g., receives the RS 240), utilizing proper duplexing capability (e.g., full-duplex) to enable reception of the echoes/reflections transmitted by the same node. In some cases, the network indicates the utilized sensing RS 235 to other (non-network) nodes or a subset of the UE nodes via RRC signaling, PDSCH or PDCCH/DCI signaling or a group-common DCI.

In some cases, when the sensing RS 235 and some of the physical DL channels share the same resources, the adjustments on the physical DL channels are indicated to the relevant UE nodes (e.g., the use of additional DMRS (demodulation reference signal) patterns to support beam variations in case of the beam sweeping combined with the DL transmissions).

As another example of the radio sensing operation 200, the base station 210 transmits the sensing RS 235 and the UE 230 (or multiple UEs) receives the reflected RS 240. The network indicates (implicitly or via direct assignment) the UE 230 to operate as the sensing Rx, including (but not limited to) a definition of the sensing RS 235, a type of the sensing measurements, and/or a reporting strategy and reporting resources. The base station 210 can signal the UE 230 via RRC or dynamically via PDCCH/DCI, group-common DCI, and/or via a part of the sensing RS 235.

In some cases, the base station 210 communicates the information regarding the sensing RS 235 to other UE nodes (e.g., the base station 220), which are not a sensing Rx, using the various signaling methods described herein. Non-sensing-Rx UEs can utilize the sensing RS 235 information to comply with an updated waveform parameter due to sensing (e.g., the modification of CP/guard-bands during active sensing periods).

As described herein, a radio sensing operation can include various elements or devices that facilitate the transfer of angle information for sensing signals between devices or nodes, which enables sensing nodes to perform accurate measurements of objects detected or sensed within target areas of a network environment.

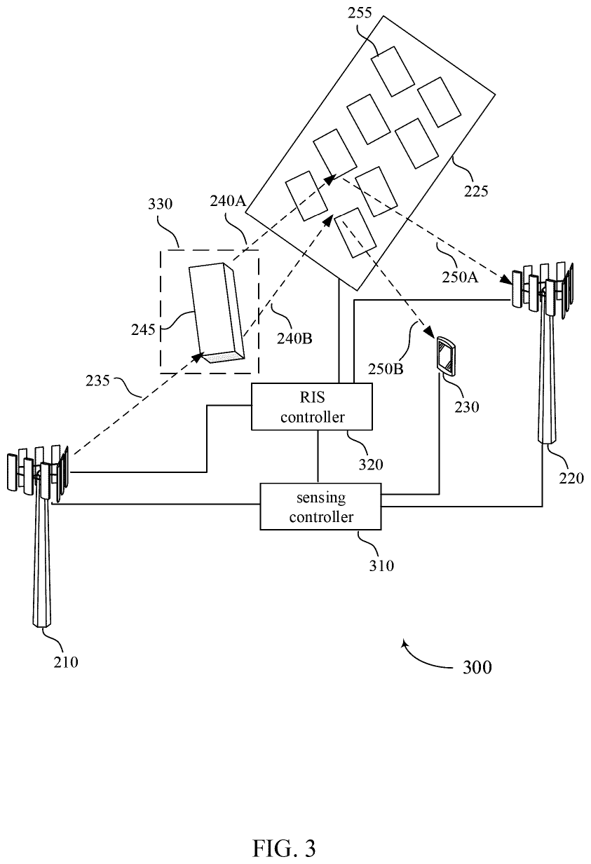

FIG. 3 illustrates an example of a diagram 300 that supports encoding angle information of incident waves during radio sending operations in accordance with aspects of the present disclosure.

A sensing controller 310 provides a RIS controller 320 with a reflection configuration. Based on the reflection configuration, the RIS 225 adjusts reflection/processing characteristics (e.g., adjusts the phase rotation and/or time-delay and/or reflection energy characteristics) of the RIS elements 255.

For example, the reflection configuration can relate an angle of an incident wave (e.g., wave 240A or wave 240B) towards the RIS 225 and one or more angles of a reflected wave 250A, 250B from the RIS 225 to a sensing node, such as the base station 220. The incident waves 240A or 240B towards the RIS 225 result from a sensing signal sent by a Tx node (e.g., the base station 210) being reflected, at least partially, by a sensing target/object (e.g., object 245) within a target area 330 towards the RIS 225.

The RIS 225 reflects the incident waves 240A, 240B as reflected waves 250A, 250B towards one or more Rx nodes (e.g., the base station 220 or the UE 230), according to or based on the reflection configuration received from the sensing controller 310. The Rx node may estimate the angle and/or angular segment of incidence towards the RIS and/or generate and transmit a measurement report, based, at least partially, on the received sensing signal (e.g., reflected waves 250A, 250B).

Upon reception of the sensing signal by the Rx node and/or reception of the Rx node measurement report at the sensing controller 310 (or a similar processor node), the sensing controller 310 estimates angle/angular segments of incidence towards the RIS 225, based at least in part on: (1) the received sensing signal, the Rx node measurement reports, and/or a RIS 225 mapping of the angle/angular segments of incidence to the RIS angle/angular segments of reflection.

Thus, FIG. 3 depicts an RIS-assisted sensing scenario, where the base station 210 acts as the Tx node and radiates a sensing signal 235 towards a target area 330. Reflecting from the target area 330 (e.g., upon detecting the object 245), the RIS 225 collects the incident waves 240A, 240B and directed reflected waves 250A, 250B to a set of sensing nodes (e.g., the base station 220 and the UE 230). Since different angles of incidence towards the different RIS elements 255 of the RIS 225 result in different angles or angular patterns of reflection, the sensing controller 310 obtains the angles of the incident waves 240A, 240B by collecting measurements performed by the set of sensing nodes (e.g., Rx nodes)

In some embodiments, the RIS controller 320 performs one or more of the following actions or operations:
Controls/adjusts the reflection characteristics (e.g., phase shift) of the configurable RIS elements 255;
Obtains information/measurement of the implemented reflection characteristics of the RIS 225;
Transmits a report of the reflection characteristics of the RIS 225;
Transmits information (e.g., RIS 225 capability information) and/or reports on the implemented reflection characteristics to the network and/or the sensing controller 310 via a physical communication channel (e.g., a wired connection, a wireless PUSCH (Physical Uplink Shared Channel), PUCCH (Physical Uplink Control Channel), a Sidelink (SL) channel, or a combination thereof);
Receives information, such as a configuration, for adjusting a reflection characterization of the RIS 225 from the network and/or the sensing controller 310 via a physical communication channel (e.g., a wired connection, a wireless PUSCH, PUCCH, or a combination thereof); Receives configuration for the transmission and reception of information; and so on.

In some embodiments, the sensing controller 310 can be part of (or operate as part of) a third-party application on a UE device, a RAN node (e.g., a gNB), a smart repeater, an IAB node, a UE/gNB-RSU, or operate as part of a core network entity, (e.g., a radio sensing management function).

In some embodiments, the sensing controller 310 performs one or more of the following actions or operations:
Collects capability information from the RIS 225 to perform sensing operations;
Collects capability information of the radio sensing-capable nodes to act as a sensing Tx node;
Collects capability information of the radio sensing-capable nodes to act as a sensing Rx node;
Determines a sensing scenario, including at least a sensing Tx node, a sensing Rx node similar or different from the sensing Rx node, an area of interest for monitoring/sensing, and/or one or multiple RIS segments to participate in a radio sensing operation;
Configures one or multiple sensing Tx nodes with a sensing signal transmission, including configurations of the time-frequency and beam resources and the RS sequence for the sensing signal;
Configures one or multiple RIS controllers 320 with reflection configuration information;
Configures one or multiple sensing Rx nodes with sensing signal reception and measurement/processing;
Configures one or multiple sensing Rx nodes with a sensing measurement reporting configuration (e.g., reporting criterion, reporting time-frequency and beam resources, reporting information type, and so on);
Performs processing of the collected sensing measurements from the sensing Rx nodes and obtains desired sensing information;
Configures one or multiple processor entities to obtain an indicated set of desired sensing information outcomes, based on, among others, the received reports of the sensing Rx nodes;
Reports the obtained sensing information, upon reception of the sensing Rx reports and processing, to a RAN and/or network entity, according to a prior indication/configuration; and so on.

Thus, in some embodiments, the sensing controller 310 transmits sensing configuration information cause the following actions or operations:

The sensing Tx nodes transmit the sensing signal, according to the received configuration for sensing signal transmission, which is sent to the RIS 225 after reflecting off of the object 245 within the target area 330;
One or more RIS entities 225 reflect the incident wave, where the reflection is according to the received RIS reflection configuration;
One or multiple sensing Rx nodes receive the reflections from the RIS 225, and perform sensing measurements, according to the received reception and measurement and/or processing configuration from the sensing controller 310;
One or multiple sensing Rx nodes transmit a report from the performed measurements to a processor entity, according to the received reporting configuration from the sensing controller 310; and so on.

In some embodiments, the set of sending nodes can include a processing entity, which performs measurements, generates sensing reports, and so on, during radio sensing operations. The processing entity can perform the following actions or operations:
Receive a configuration from the sensing controller 310 for: (1) reception of the sensing Rx measurements, including one or multiple of the time-frequency resources for the reception of the sensing Rx measurements and type of the embedded measurement report, (2) the desired sensing processing (e.g., an object presence, object position with tolerable error of 1 m for 99% percent of the times or any sensing information to be obtained from the sensing Rx measurements), (3) and/or reporting, including a reporting criteria (e.g., report the object position and velocity when an object is detected within an area of interest), reporting data type, and time/frequency resources to transmit the report, and so on;
Collect the sensing Rx measurements, according to the received configuration;
Perform sensing processing according to the received configuration;
Report the obtained sensing information according to the received configuration; and so on.

In some embodiments, the reflection configuration includes:
An element phase rotation value, element amplitude/attenuation value, or a quantized and/or a compressed version thereof;
One or more of an indication of an incident angle/angular segment (e.g., defined in azimuth, elevation, or jointly in azimuth and elevation according to a global or local coordinate system), and one or multiple reflection angle/angular segments, and/or reflected energy distribution, through which the incident wave with the indicated angle/angular segment is reflected. For example, an incident wave within angular segment of [30 45] in azimuth and [60 75] in elevation (according to a globally or locally known coordinate system to the RIS controller) is configured to be reflected towards angular segment of [0 15] in azimuth and [30 45] in elevation with 0.3 of the total reflection energy and towards angular segment of [20 45] in azimuth and [10 25] in elevation with 0.7 of the total reflection energy;
One or more of an indication of one or multiple incident angles/angular segments, and one reflection angle/angular segment, through which the incident waves with the indicated angles/angular segments are reflected; and so on.

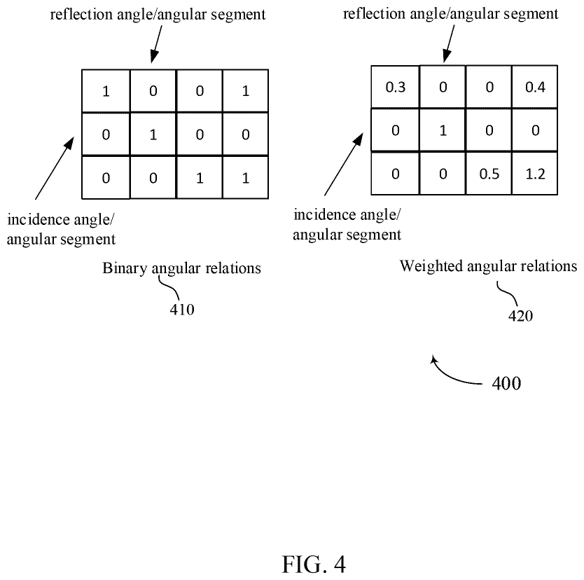

In some embodiments, the reflection configuration information of the RIS 225 includes a table, such as a 2-D table indicating a binary value as an angular relation between an incidence angle/angular segment and a reflection angle/angular segment. FIG. 4 illustrates an example of a diagram 400 that supports relating incident angles or angular segments to reflection angles or angular segments in accordance with aspects of the present disclosure.

For example, angular segments of incidence are mapped to the angular segments of reflection, as shown by a binary angular relations segment 410. The table also includes a weighted angular relations segment 420, where a weighted energy distribution is also indicated, in addition to the relations of the incident-reflection angular segments in segment 410. Thus, the table presents angular segments of incidence being connected to the angular segments of reflection (in segment 410), where, in segment 420, an energy distribution weight/ratio is also indicated in addition to the relations of the incident-reflection angular segments according to which the RIS controller 320 shall design the reflection phase rotations.

The values of the indicated energy distributions define the reflective energy of the reflected waves in different angular segments. In some cases, the weight values are normalized to the total reflection energy or to the total incident wave energy. The angular segments are defined according to a global or local coordinate system known to the RIS controller 320, and include one or more angular points, or a range (e.g., [10-30] degrees in azimuth), or an angular segment jointly defined over azimuth and elevation (e.g., [10-40] degree of azimuth and [30-45] degrees of elevation), or an angular width around an angle (e.g., any angle with less that 10 degrees deviation (in elevation, azimuth, or jointly) with the central angle of 20 in azimuth and 45 in elevation), according to a globally or locally known coordinate system.

In some embodiments, the sensing controller 310 or the RIS controller 320 defines the the angular segments and/or maps the incident angular segments to the reflected angular segments, based on the one or more of the following characteristics or parameters:

Indicated RIS capability, (e.g., number of elements and phase rotation resolution), angular resolution including a minimum separation distance for seperable incidence and/or reflection beam directions, supported angular region (e.g., range of the observable angles), and so on;
the desired area of sensing according to a globally or locally known coordinate system;
an expected object size;
an expected number of sensing targets present at the same time;
a desired sensing accuracy, (e.g., desired detection probability), tolerable false alarm probability, tolerable positioning error (e.g., MSE), and so on;
available sensing Tx nodes and their position and/or capabilities;
available sensing Rx nodes and their position and/or reflection angles of the RIS in the propagation path towards the sensing Rx nodes (including LOS and NLOS paths from RIS towards the sensing Rx) and/or sensing Rx node capability;
time-frequency and/or energy resources at the sensing nodes;
available/capable RISs for sensing, and the position, orientation, and/or capabilities of the RISs; and so on.

In some embodiments, the RIS controller 320 determines the angles/angular segments of incidence according to, at least, the indicated area of interest for sensing, the indicated sensing Rx node positions and/or angles towards the RIS and/or reflection angles of the RIS 225 in the propagation path towards the sensing Rx node (including LOS and NLOS paths from RIS towards the sensing Rx) and RIS capability, or a combination thereof.

In some embodiments, the RIS controller 320 determines the angles/angular segments of reflection according to, at least, the sensing Rx node positions and/or reflection angles of the RIS in the propagation path towards the sensing Rx node (including LOS and NLOS paths from RIS towards the sensing Rx).

In some embodiments, the sensing controller 310 determines the incident angles/angular segments and/or the reflection angles/angular segments, based on the indication of RIS capability of one or multiple RISs, the area of interest for sensing, and the available sensing Rx nodes and the available sensing Tx nodes. The sensing controller 310 indicates the determined angular segments of incidence and/or reflection to the RIS controller 320.

In some embodiments, the number of incident and/or reflection angle/angular segments are determined based on the pre-defined supported number of the angular segments, such as based on the supported mapping matrices. In some embodiments, the angular segments are determined with an equal width, such as by dividing the area of interest into equally spaced angular segments.

In some embodiments, when the angles/angular segments of incidence and/or the angles/angular segments of reflection are determined by the RIS controller 320, the determined angles are indicated to the sensing controller 310.

In some embodiments, the reflection angular pattern (e.g., a row of the example angular relations segment 410 in FIG. 4), is defined according to a known codebook for the RIS controller 320, where the mapping table is constructed at the RIS controller 320 based on the received indication/configuration of the sensing controller and the known/pre-defined codebook.

In some embodiments, the codebook is based on:
A number of separable/supported incident angular segments towards the RIS 225, where the number is determined according to the size of the area of interest for sensing, the expected object size, distance of the area of interest towards the sensing Tx node, the RIS angular resolution, or a combination thereof;
A maximum and/or expected number and/or distribution of the simultaneously active incident angular segments (e.g., expected object size), in terms of the number of spanning incident angular segments, expected number of the objects present at the same time, probability distribution of the number of objects to be present at the same time, probability distribution of the size of the object in terms of the number of involved angular incident segments, or a combination thereof. In some embodiments, the maximum and/or expected number and/or distribution of the simultaneously active incident angular segments is indicated to the RIS controller 320 via an index from a codebook, where the codebook includes different possible combinations of the maximum and/or expected number and/or distribution of the simultaneously active incident angular segments. In some embodiments, an index of the codebook indicates the situation where the presence of X (e.g., 2) number or objects at the same time is not likely (below a probability threshold). In some embodiments, an index of the codebook indicates the situation where simultaneous reflections at Y (e.g., 2) number of adjacent angular segments is not likely;
A number of supported reflection angle/angular segments, representing the dimension of the codeword space. In some implementations, the number of the supported reflection angles is determined based on the RIS reflection angle resolution, the number of sensing Rx nodes associated to the RIS segments with LOS propagation condition towards RIS, and number of the reflective paths from RIS to the sensing Rx nodes, or a combination thereof;
A CSI of the RIS towards sensing Rx nodes via the LOS and/or the NLOS propagation paths; and so on.

In some embodiments, the codebook is a linear block code, where the codebook input is a binary input where “0” indicates no incident power at the angular segment (or below a threshold), and “1” indicates that the angle of incidence includes non-zero energy (or above a threshold). In some implementations, the linear block code is constructed according to the generator matrix of an error correction code (e.g., Walsh-Hadamard code or a Reed Solomon code).

In some implementations, when the number of supported reflection angle/angular segments is larger than the number of supported incident angle/angular segments, the linear code includes an identity matrix and a shared part, where the reflection angle/angular segment within the identity matrix is uniquely mapped to an incidence angle/angular segment, and a shared section, where the angle/angular segment of reflection is mapped to multiple incident angle/angular segments. In some implementations, the shared section of the linear code is implemented according to an indicated combination to the RIS controller 320.

In some embodiments, the energy distribution of the reflected wave through different angular segments is determined based on, at least, the CSI of the reflected wave through the reflected angular segment towards the sensing Rx node.

In some embodiments, where the maximum and/or expected number of the simultaneously active incident angular segments is significantly smaller than the number of separable/supported incident angular segments towards the RIS 225, the reflection angular signatures are generated according to a known sensing matrix and/or satisfies null space properties for a constant value of below 0.5 and/or satisfies the restricted isometry property up to a restricted isometry constant.

In some embodiments, an angular relation is indicated to the RIS controller 320 based on whether the incident wave at the indicated angular segments may not be leaked/reflected towards the indicated reflection angular segments or shall be kept within an indicated threshold on the reflection energy or a normalized reflection energy. In some embodiments, an angular relation is indicated to the RIS controller 320, based on whether the incident wave energy outside of the indicated incidence angular segments may not be leaked/reflected at the RIS 225 into indicated reflected angular segments. For example, the angular segments corresponding to a first sensing area of interest is indicated to be suppressed in reflection towards the angular segments corresponding to a second sensing area of interest. As another example, the angular incidence of the communication nodes are indicated to not to be reflected in the reflection angular segments used to convey reflections from a sensing area of interest.

In some embodiments, when RIS 225 is a network node, the RIS controller 320 and the RIS 225 are part of the same device or entity. In some embodiments, the sensing controller 310 and the RIS controller 320 are the same function and/or implemented within the same node. In some embodiments, all or a subset of the functionalities described with respect to the sensing controller 310 can be performed by the RIS controller 320. In other embodiments, all or a subset of the functionalities indicated for the RIS controller 320 can be performed by the sensing controller 310.

In some embodiments, capabilities of the RIS 225 can be defined or indicated by one or more information elements, including:
A type of processing that is supported via the RIS elements 255 (e.g., a power angular spectra measurement at the RIS 225);
A supported angular range of incidence, according to a global or local coordinate system;
A supported angular range of reflection, according to a global or local coordinate system;
A supported angular resolution;
A number of adjustable reflection elements;
A number of bits describing phase adjustment resolution for the RIS 225;
Additive noise variance at the reflecting elements of the RIS 225;
Multiplicative noise variance at the reflecting elements of the RIS 225;
Passive or active reflective element capabilities of the RIS 225;
Reflector surface size or aperture size of the RIS 225;
Reflector surface shape of the RIS 225;
Reflector surface angle or orientation of the RIS 225;
Reflector surface coverage distance and/or area for communication and/or sensing;
An operating frequency band for the RIS 225; and so on.

As described herein, in some embodiments, time information is mapped to incidence angles. For example, the sensing controller 310 provides the RIS controller 320 with one or more time segments, where each time segment includes one or multiple symbols. Related to each time segment is reflection characterization configuration information, where each includes at least an indication of one angular point/segment of incidence and at least one angular point/segment of reflection.

Thus, one or more incidence angular segments at the RIS 225 can be identified according to the received sensing signal at the sensing Rx node at different time segments, according to the configurations indicated by the sensing controller 310. The RIS controller 320, based on the received reflection characterization information corresponding to a time segment, adjusts its reflection/processing strategy (e.g., element phase rotations and/or element reflection energy corresponding to the indicated time segment). The sensing Rx node may estimate the angle/angular segment of incidence towards the RIS 225 and/or generate and transmit a measurement report, based, at least in part, on the received sensing signal.

Upon reception of the sensing signal by the sensing Rx node and/or reception of the sensing Rx node measurement report at the sensing controller 310 and/or a processor node, the angle/angular segments of incidence towards the RIS 225 are estimated, based on at least in part, on the received sensing signal and/or sensing Rx measurement reports, and the RIS 225 mapping of the angle/angular segments of incidence to the RIS 225 angle/angular segments of reflection and the associated time pattern. For example, a sensing area may be divided into multiple zones, with each zone associated with a time index. The RIS controller 320 may only transmit the angular segments of the respective zone at the specified time instance. The mapping of the zones to time index may already be known to sensing Rx or may be configured by the sensing controller 320 before the sensing operation.

In some implementations, the relationship between zones and time segments may be based on symbol number in a slot. For example, using NR numerology, the sensing area may be divided into 7 or 14 zones, where each zone corresponds to one symbol number in a slot (e.g., sub-slot/slot based). Upon reflection from one or more zones, the RIS controller 320 transmits the sensing information only in the OFDM symbol number associated with one or more zones (from which reflection is received), thus indicating to the sensing Rx about the information of the sensing area. In some cases, the relationship between sensing area zones and the time segments is based on slot numbers, where each zone information is coupled to one slot index of a frame.

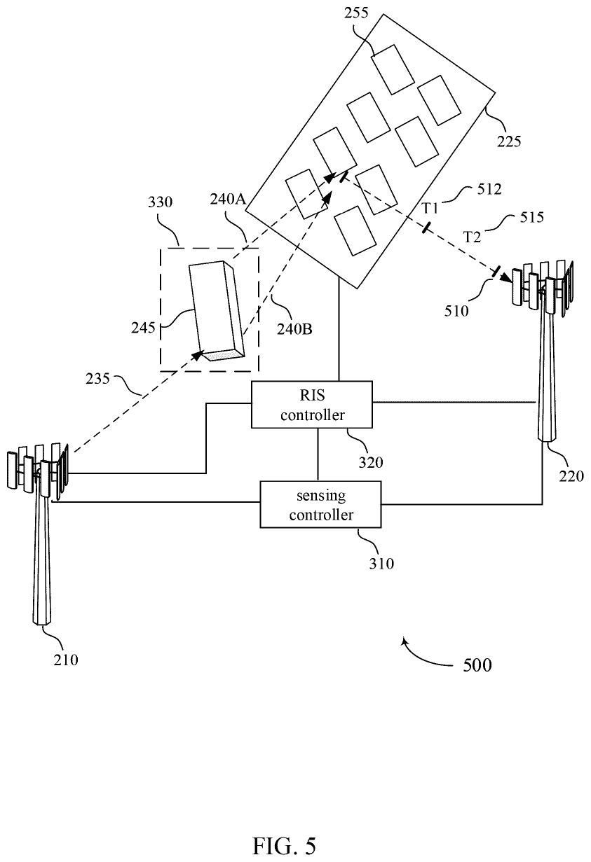

FIG. 5 illustrates an example of a diagram 500 that supports encoding time information of incidence angles during radio sending operations in accordance with aspects of the present disclosure. As depicted, there is time-domain encoding of the RIS incidence, where the reflections 510 from the sensing area of interest 330 are directed towards the sensing Rx nodes associated with the RIS 225. The RIS reflection characteristic is configured differently at different time segments (e.g., T1 512 or T2 515), where at each time segment, a wave at a different angle of incidence is reflected towards the sensing Rx node. In some cases, the angular separation of each angular segment is performed separately or jointly in the azimuth and elevation domains. Thus, the sensing controller 310 obtains the reflection angle of the sensing signals 240A, 240B off the object 245 towards one of the RIS segments 255, based on the observed time pattern at the sensing Rx nodes.

Thus, the RIS reflection characteristic is configured differently at different time segments (e.g., at T1 and T2), where at each time segment, a wave at a different angle of incidence is reflected towards the sensing Rx node (e.g., the base station 220).

In some embodiments, multiple sensing Tx nodes can transmit the sensing signal. In some embodiments, the Tx nodes transmit a different sensing signal, such as by using different signal sequences or transmitting at different time and/or frequency resources. The reflection from the RIS 225, the reception by the sensing Rx nodes, and the subsequent sensing Rx measurements and reporting can be performed separately for each Tx node transmission and/or jointly for multiple Tx node transmissions.

In some embodiments, the incident angle and reflection angle relationships indicated to the RIS controller 320 at different time segments are generated according to a codebook implemented in the time domain, which maps each of the supported incident angle/angular segments by the RIS 225 to a reflection time pattern.

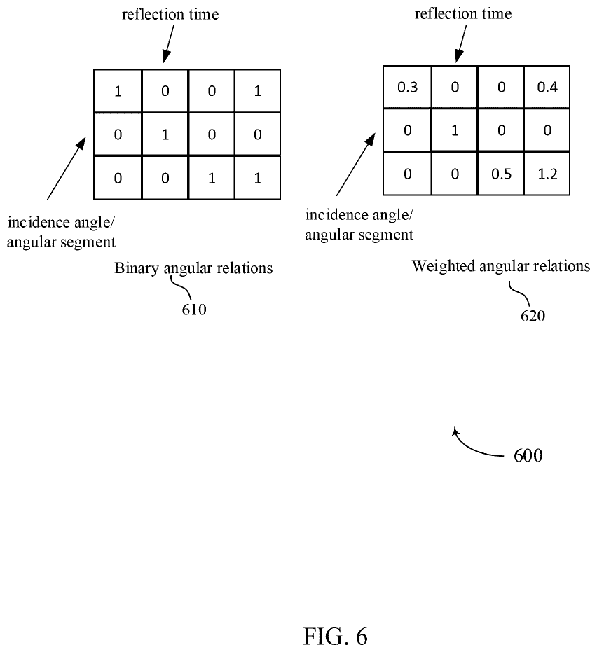

FIG. 6 illustrates an example of a diagram 600 that supports relating incident angles or angular segments to reflection times in accordance with aspects of the present disclosure. The diagram 600 depicts a table that defines the incident angle to reflection time relations, such as via a binary angular relations segment 610 or a weighted angular relations segment 620.

In some cases, when a column includes multiple non-zero elements, the column indicates an instance at which multiple related incident angular segments are reflected towards the receiver node. Moreover, when an incident angle appears more than once in a row, the incident angle is reflected towards the sensing Rx node in multiple time segments. In some embodiments, the table can be adopted from the generator matrix of a known coding method, such as a Walsh-Hadamard linear error correction code.

In some embodiments, the time segments over which the angular encoding is implemented is indicated jointly to the RIS controller 320 as a time pattern. In some embodiments, the indications of the incident angle to reflection time relations, the time segments, the incident angles and their sequence/order, and/or the location of the sensing Rx nodes are indicated jointly to the RIS controller 320 and/or or via separate indications.

In some implementations, when the number of supported reflection angle/angular segments are larger than the number of supported incident angle/angular segments, the linear code includes an identity matrix and a shared part, where the reflection angle/angular segment within the identity matrix is uniquely mapped to an incidence angle/angular segment, and a shared section, where the angle/angular segment of reflection is mapped to multiple incident angle/angular segments. In some implementations, the shared section of the linear code is implemented according to an indicated combination to the RIS controller 320.

Thus, the table depicted in FIG. 6 provides an example of angular incidence to reflection time relations, where the angular segments of incidence are connected to the time segment of reflection, as shown in segment 610. In segment 620, an energy distribution weight/ratio is also indicated in addition to the relations of the incident-reflection time segments according to which the RIS controller 320 shall design the reflection phase rotations at different times.

As described herein, in some embodiments, the sensing controller 310 provides the RIS controller 320 with an indication of one or more time segments and, related to each time segment, reflection characterization configuration information, including an indication of one or more angular point/segments of incidence and at least one angular point/segment of reflection. The one or multiple incidence angular segments at the RIS 225 can be identified according to the received sensing signal at different sensing Rx nodes, and at different time segments, according to the configurations indicated by the sensing controller 310.

The RIS controller 320, based on the received reflection characterization information corresponding to a time segment, adjusts its reflection/processing strategy (e.g., element phase rotations and/or element reflection energy) corresponding to the indicated time segment. In some embodiments, the reflection angular pattern at different time segments is defined/indicated according to a codebook. In some embodiments, the codebook is based on:
A number of separable/supported incident angular segments towards the RIS 225;
A maximum and/or expected number of the simultaneously active incident angular segments;
A number of supported reflection angle/angular segments. In some embodiments, the number corresponds to the number of sensing Rx nodes with LOS path towards the RIS segment, and/or the reflective paths from the RIS towards the sensing Rx nodes. In some embodiments, the number is limited by the RIS reflective angular range and/or resolution;
A number of time segments over which the RIS 225 performs separated reflection and sensing Rx nodes perform separated reception of the transmitted sensing signal; and so on.

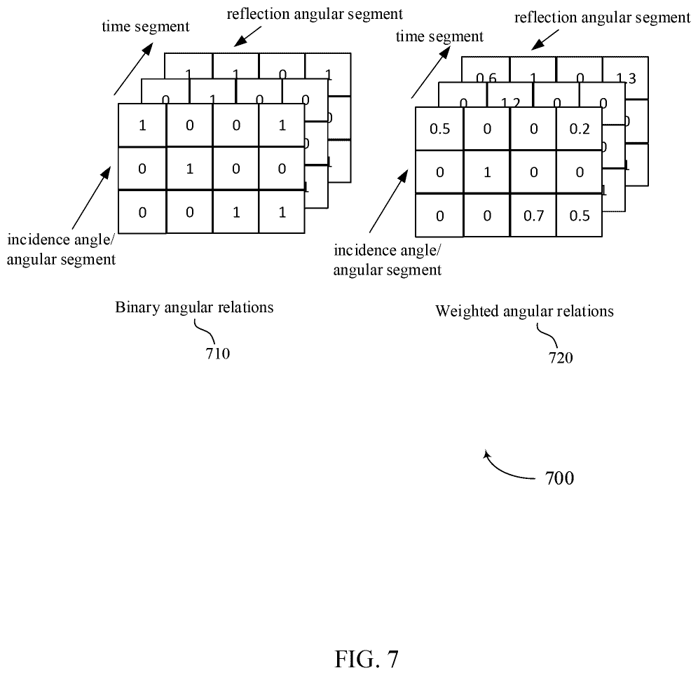

FIG. 7 illustrates an example of a diagram 700 that supports relating incident angles or angular segments to reflection times and reflection angles in accordance with aspects of the present disclosure. The diagram 700 depicts a table that relates angular segments of incidence to the time segment of reflection, as shown in segment 710. In segment 720, an energy distribution weight/ratio is also indicated in addition to the relations of the incident angle to the reflection angular/time segments, according to which the RIS controller 320 shall design the reflection phase rotations at different times.

In some embodiments, the dimension of the signal space is determined according to the supported number of the incident angular segments towards the RIS 225 from the sensing area. In some embodiments, the dimension of the code space is determined according to the combination (e.g., multiplication) of the total number of supported paths from the RIS 225 towards the sensing Rx nodes and the number of time segments. In some embodiments, the table (e.g., the diagram 700) defining the angular incidence to reflection angle and time segment relations is generated in two dimensions, where all possible time segments and the reflection angular segments are presented according to a certain order as a single coding dimension. In some embodiments, the table defining the angular incidence to reflection angle and time segment relations is generated and/or indicated based on a known codebook (e.g., adopted from the generator matrix of a known linear error correction code).

In some embodiments, the angle of the incidence wave at the RIS 225 is obtained at the sensing Rx node, at the sensing controller 310 and/or a processor node (based on the configuration of the sensing controller 310) based on the measurement reports received from the one or more sensing Rx nodes.

In some implementations, the sensing controller 310 collects the capability of the RIS 225 for the angular separation/resolution and the capability of the RAN nodes to act as sensing Tx and/or sensing Rx nodes. Moreover, the sensing controller 310 obtains a sensing task, e.g., a a scenario of monitoring a cross section of a road (e.g., the target area 330) for pedestrians that are present at the road cross section, including a requested sensing quality indication (e.g., probability of detection of higher than 99%). The sensing controller 310 determines one or multiple sensing Tx nodes for transmitting sensing signals based on the proximity to the desired area for sensing, and multiple sensing Rx nodes for receiving the sensing signals, according to the sensing Rx nodes observability of the desired area for sensing and/or observability of the RIS 225, the RIS capability for angular separations between different reflection directions and the desired sensing quality.

Then, the sensing controller 310 constructs the angular segments of incidence towards the RIS 225, based on the separable angular segments at the RIS 225, and the angular region (with respect to the RIS 225) of the area of interest for sensing, according to a known coordinate system by the RIS 225. The sensing controller 310 determines the angular segments of reflection from the RIS 225, according to the position of the sensing Rx nodes and the separable propagation paths (LOS and NLOS) between the RIS and the sensing Rx nodes, and the received RIS 225 capability.

The sensing controller 310 determines the number and time instances (symbols) for the sensing operation, including the total duration of the sensing signal transmission (indicated as a periodic RS resource), and multiple time patterns within the sensing duration/RS for which the reflection (at the RIS 225) and reception of the sensing signal (at sensing Rx nodes) are defined independently. In some cases, this is based on the desired estimation accuracy of the angle of incidence towards the RIS 225, the number of the separable propagation paths from the RIS 225 to the sensing Rx nodes and/or the expected speed of the object of interest.

Based at least in part on the determined separable propagation paths from the RIS 225 to the sensing Rx nodes (each corresponding to an angular segment of reflection from the RIS 225 and a reception by a sensing Rx node), number of symbols/occasions for which the RIS 225 may take separate reflection configurations, the incident angular segments, and the desired accuracy of the estimation of the incident angular segment, the sensing controller 310 determines a mapping between the incident angular segment and the reflection angular segments (corresponding to a separable propagation path between the RIS 225 and the sensing Rx nodes).

In some cases, the mapping is depicted as follows:

$$G = \overbrace{[ \begin{matrix}{I}_{d}^{1} \\ ⋮ \\ {I}_{d}^{l} \\ R\end{matrix} ]} \} , R ∈ {\{ 0 , 1 \}}^{r \times d} , G ∈ {\{ 0 , 1 \}}^{ld + r \times d} ;$$

where the parameters of the mapping are defined in Table 1:

TABLE 1
Dimension Factors for the Matrix G

| | |
|---|---|
| G | Matrix of binary values, defining which of the RIS incident angular segments will be reflected |
| | towards which of the sensing Rx reception paths (corresponding to a RIS reflection angular |
| | segment) at a time instance. The values “0” (“1”) indicate that the wave associated with the |
| | said incident angle at the respective time instance will not be (will be) directed towards the |
| | corresponding RIS reflection angle. |
| I | Identity matrix with dimension as subscript |
| R | Matrix defining the separable receptions caused by RIS incident wave angle from any one or |
| | more of multiple incident angles |
| d | Number of the incident angular segments towards the RIS |
| r | Number of redundancies; Number of separately observable receptions which are associated |
| | with multiple incident angular segments at the RIS (i.e., when an incidence angle is reflected |
| | towards sensing Rx nodes via separable receptions via multiple transmission/reflection |
| | instances) |
| l | Number of repetitions; where energy of the same angular incidence towards the RIS is |
| | received separately, by different sensing Rx nodes, different angular receptions of a same |
| | sensing Rx node, at different time instances, or a combination thereof. |
| i | Index of the sensing Rx nodes |
| t | Index of time occasions/symbols for which the reflection strategy at the RIS can be |
| | independently defined |
| Cᵢₜ | Number separable receptions at the i-th sensing Rx node and at the time occasion t, |
| | corresponding to a RIS reflection angle/angular segment associated to the said reception |

As shown, an angle of incidence (d) indicates the number of distinct angular segments of incidence towards the RIS, and the number ld+r, indicates the total number of separable receptions via RIS reflection at different angles and different time instances.

The mapping also includes the number of sensing Rx nodes, the number of separable receptions at the sensing Rx nodes (corresponding to reflection of different angular segments from the RIS), the number of time occasions/symbols for which the RIS reflection configuration can be separately defined, the number of separable reception repetitions of an incident angle, the number of separable reception redundancies of an incident angle. An angle of incident (d) indicates the number of distinct angular segments of incident towards the RIS, and the number ld+r, indicates the total number of separable receptions via RIS reflection at different angles and different time instances. The reflection characteristic of the RIS can be adjusted based on the mapping of the incident angles to the reflection angles described by the matrix G.

In some embodiments, the sensing Rx nodes report measurements (according to a received reporting configuration, towards sensing controller node, or a separate node that collects the received measurements and performs processing of the received measurements) on the separable receptions, corresponding to the received sensing signal associated to one or multiple time-patterns for which RIS reflection shall be independently configured and/or the received sensing signal at separate beams/angle/angular sections at one or multiple sensing Rx nodes.

In some implementations, the sensing controller 310 (or the processor node) determines the object presence, and one or multiple incident angles of the object reflection towards the RIS 225, based, at least in part, on the received measurements, and/or the known mapping of the angle/angular segments of incidence and angle/angular segments of reflection and/or the associated time patterns (e.g., knowledge of the matrix G). Further, based, at least in part, on the identified one or multiple angles, the sensing controller 310 or processor node then determines the object position and/or the object size and/or the object shape.

As described herein, in some embodiments, the sensing controller 310 provides the RIS controller 320 with reflection characterization configuration information corresponding to least one time segment, where an RIS segment adjusts its reflection/processing strategy (e.g., elements phase rotations and/or element reflection energy) at different time segments.

In some cases, the sensing controller 310 configures one or more Tx nodes for transmission towards the RIS segment, according to indicated sensing RS resources configured by the sensing controller 310 and one or multiple Rx nodes for reception of the reflections from a potential object area, according to the indicated sensing RS resources, to perform sensing measurements and reporting, according to the received configurations from the sensing controller 310.

The reflection characterization includes one or more relations between one or more incidence angular segments towards the RIS 225, and one or more reflection angular segments from the RIS 225. According to the configured reflection characterization information, the angle of an incident wave towards the RIS segment and the one or multiple angles of the reflected wave from the RIS segment are related according to a generated or stored mapping by the sensing controller 310. Thus, upon reception of the reflected sensing signal by the one or more sensing Rx nodes, the sensing controller 310 may obtain the incidence angle of the sensing signal towards the object, and obtain sensing information, among other information, based on the obtained incidence angle of the sensing signal propagation towards the object.

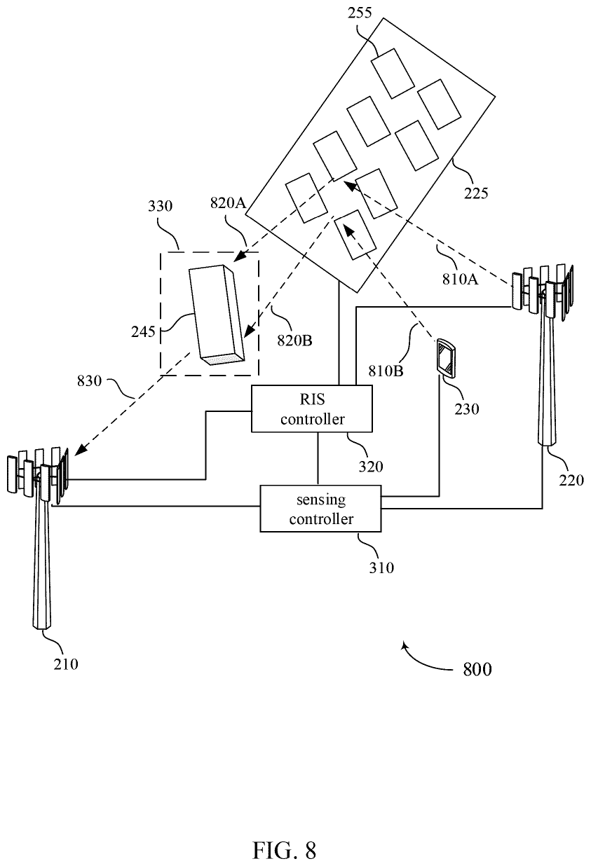

FIG. 8 illustrates an example of a diagram 800 that supports radiating sensing signals to a RIS during radio sending operations in accordance with aspects of the present disclosure. In some embodiments, the reflected angle from the RIS segment is encoded according to an indicated angular relation and/or an indicated time pattern.

As depicted, the RIS 225 enables radiation of sensing signals 810A, 810B (e.g., from the base station 220 and UE 230 acting as Tx nodes) towards the target area 330. The sensing controller 310 obtains a RIS 225 angle of incidence according to the Tx nodes and/or the RIS incidence angular segment or can obtain the angle of incidence according to the time segment at which the sensing signal is reflected from the RIS segment, according to the received time and angular relations configurations from the RIS controller 320 (as described herein).

In some embodiments, the time segments include one or multiple symbols, within one or multiple slots. In some embodiments, the symbols belonging to the same time segment are positioned adjacent to each other, follow a constant spacing, or follow an indicated symbol pattern within a slot (e.g., the symbols {1,3,4} within a slot contain a time segment during which an indicated angular relation holds).

In some embodiments, the different time segments are defined at different slots. In some embodiments, multiple time segments are defined within one slot. For example, one time segment includes one symbol, with multiple adjacent symbols within a first slot containing multiple time segments and multiple adjacent symbols within a second slot containing multiple other time segments.

In some embodiments, any of the configurations/indications, sensing signal/RS and reporting described herein can be received by the sensing Rx nodes, transmitted by the sensing Rx nodes, received by the sensing Tx nodes, transmitted by the sensing Tx nodes, received by the RIS controller 320, transmitted by the RIS controller 320, and/or transmitted and/or received by the sensing controller 310, via the UL, DL or SL physical data and/or control channels defined within the communication network (e.g., NR PBCH (Physical Broadcast Channel), PDSCH (Physical Downlink Shared Channel), PDCCH, PUSCH, PUCCH, PSBCH (Physical Sidelink Broadcast Control Channel), PSCCH, PSSCH).

In some embodiments, one or multiple of the configurations/indications or part of information elements therein is communicated via RRC or higher layer signaling. In some embodiments, one or multiple of the configurations/indications or part of information elements thereof is communicated between the network and the sensing Rx node via a sensing Rx node-specific DCI or a group-common DCI or a broadcast or a multicast message. In some embodiments, different configurations/indications and/or different information elements within one configuration are communicated via different signaling processes. In some implementations, part of the information elements may be communicated to the RIS controller 320 and/or the sensing Tx and Rx nodes via the RRC or higher-layer signaling, whereas the activation of the sensing operation and type of the processing outcome may be defined dynamically via the sensing Rx node-specific DCI (e.g., on the PDCCH) or a group common DCI, or a MAC-CE element. In some embodiments, one or multiple of the configurations/indications or part of information elements therein are communicated via NAS signaling exchange between the sensing controller 310 as a core network entity and the sensing Rx node, sensing Tx nodes, RIS controller, or various combinations.

Thus, as described herein, a radio sensing operation that employs a RIS, such as the RIS 225, can benefit from the following:
The time, angle, or joint time-angle coding of a wave incidence angle towards the RIS 225, in a system including at least a transmitter, a RIS/repeater and a receiver;
The configuration of a radio sensing apparatus, including at least a transmitter, a RIS and a receiver, where the configuration includes a configuration of a reflection strategy at the RIS 225 and a configuration of sensing measurement at the receiver;
The implementation and configuration of the time-angle coding of the incidence angle via angle/angular segment mapping types (between the incident and reflection wave angles), including a unique mapping, redundant mapping, and repeated mapping, a time pattern, a joint time-angle/angular segment mapping, and/or a codebook-based indication;
The signaling of tolerable energy leakage of the RIS angular segments of incidence towards angular segments of reflection, including leakage from a known angle/angular segment, and leakage to a known angle/angular segment; among other features described herein.

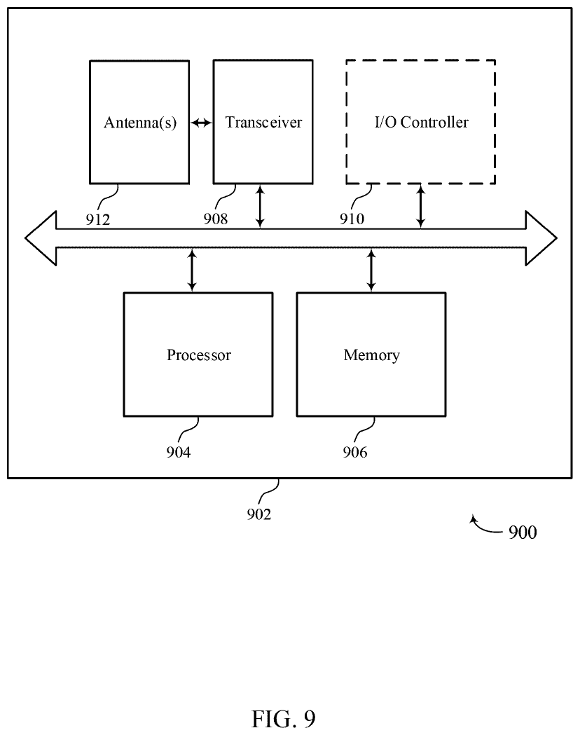

FIG. 9 illustrates an example of a block diagram 900 of a device 902 that supports encoding time and/or angle information of incidence angles during radio sending operations in accordance with aspects of the present disclosure. The device 902 may be an example of a network entity 102 as described herein. The device 902 may support wireless communication with one or more network entities 102, UEs 104, or any combination thereof. The device 902 may include components for bi-directional communications including components for transmitting and receiving communications, such as a processor 904, a memory 906, a transceiver 908, and an I/O controller 910. These components may be in electronic communication or otherwise coupled (e.g., operatively, communicatively, functionally, electronically, electrically) via one or more interfaces (e.g., buses).

The processor 904, the memory 906, the transceiver 908, or various combinations thereof or various components thereof may be examples of means for performing various aspects of the present disclosure as described herein. For example, the processor 904, the memory 906, the transceiver 908, or various combinations or components thereof may support a method for performing one or more of the operations described herein.

In some implementations, the processor 904, the memory 906, the transceiver 908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 904 and the memory 906 coupled with the processor 904 may be configured to perform one or more of the functions described herein (e.g., executing, by the processor 904, instructions stored in the memory 906).

For example, the processor 904 may support wireless communication at the device 902 in accordance with examples as disclosed herein. The processor 904 may be configured as or otherwise support a means for transmitting, to a first device, a first configuration for transmitting a sensing signal to a target area and transmitting, to a second device, a second configuration for reflecting a set of incident waves to a set of sensing devices within the target area based at least in part on the second configuration.

The processor 904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 904 may be configured to operate a memory array using a memory controller. In some other implementations, a memory controller may be integrated into the processor 904. The processor 904 may be configured to execute computer-readable instructions stored in a memory (e.g., the memory 906) to cause the device 902 to perform various functions of the present disclosure.

The memory 906 may include random access memory (RAM) and read-only memory (ROM). The memory 906 may store computer-readable, computer-executable code including instructions that, when executed by the processor 904 cause the device 902 to perform various functions described herein. The code may be stored in a non-transitory computer-readable medium such as system memory or another type of memory. In some implementations, the code may not be directly executable by the processor 904 but may cause a computer (e.g., when compiled and executed) to perform functions described herein. In some implementations, the memory 906 may include, among other things, a basic I/O system (BIOS) which may control basic hardware or software operation such as the interaction with peripheral components or devices.

The I/O controller 910 may manage input and output signals for the device 902. The I/O controller 910 may also manage peripherals not integrated into the device M02. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. In some implementations, the I/O controller 910 may be implemented as part of a processor, such as the processor M06. In some implementations, a user may interact with the device 902 via the I/O controller 910 or via hardware components controlled by the I/O controller 910.

In some implementations, the device 902 may include a single antenna 912. However, in some other implementations, the device 902 may have more than one antenna 912 (i.e., multiple antennas), including multiple antenna panels or antenna arrays, which may be capable of concurrently transmitting or receiving multiple wireless transmissions. The transceiver 908 may communicate bi-directionally, via the one or more antennas 912, wired, or wireless links as described herein. For example, the transceiver 908 may represent a wireless transceiver and may communicate bi-directionally with another wireless transceiver. The transceiver 908 may also include a modem to modulate the packets, to provide the modulated packets to one or more antennas 912 for transmission, and to demodulate packets received from the one or more antennas 912.

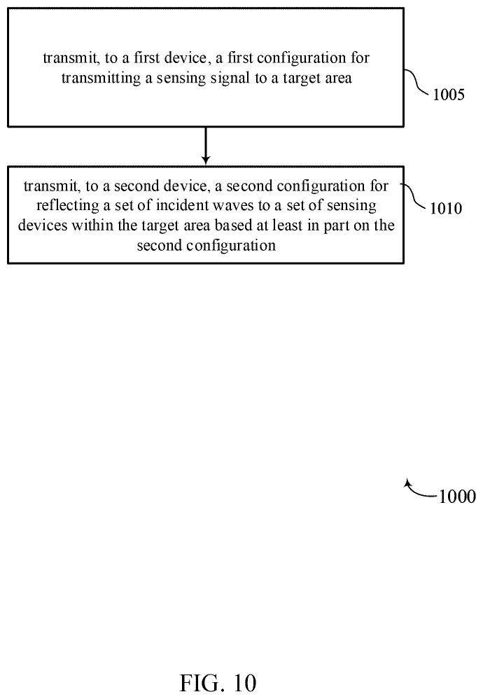

FIG. 10 illustrates a flowchart of a method 1000 that supports transmitting incidence angle information during radio sensing operations in accordance with aspects of the present disclosure. The operations of the method 1000 may be implemented by a device or its components as described herein. For example, the operations of the method 1000 may be performed by the network entity 102 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1005, the method may include transmitting, to a first device, a first configuration for transmitting a sensing signal to a target area. The operations of 1005 may be performed in accordance with examples as described herein. In some implementations, aspects of the operations of 1005 may be performed by a device as described with reference to FIG. 1.

At 1010, the method may include transmitting, to a second device, a second configuration for reflecting a set of incident waves to a set of sensing devices based at least in part on the second configuration. The operations of 1010 may be performed in accordance with examples as described herein. In some implementations, aspects of the operations of 1010 may be performed by a device as described with reference to FIG. 1.

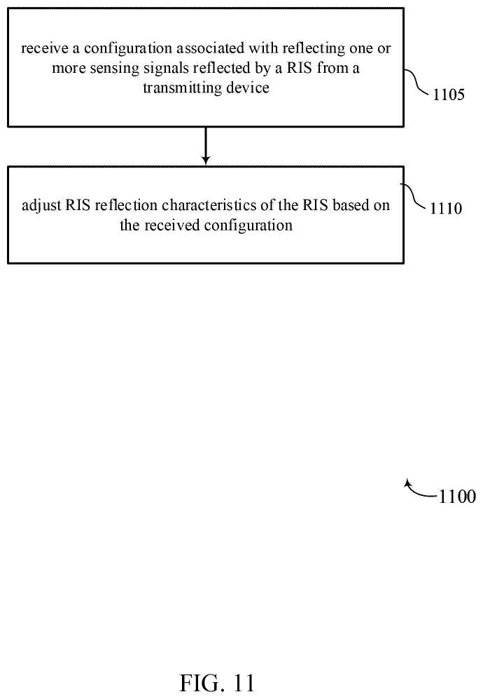

FIG. 11 illustrates a flowchart of a method 1100 that supports a RIS controller modifying reflection characteristics of a RIS during radio sensing operations in in accordance with aspects of the present disclosure. The operations of the method 1100 may be implemented by a device or its components as described herein. For example, the operations of the method 1100 may be performed by the RIS 225 or RIS controller 320 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1105, the method may include receiving a configuration associated with reflecting one or more sensing signals from a transmitting device. The operations of 1105 may be performed in accordance with examples as described herein. In some implementations, aspects of the operations of 1105 may be performed by a device as described with reference to FIG. 1.

At 1110, the method may include adjusting one or more RIS reflection characteristics of the RIS based on the received configuration. The operations of 1110 may be performed in accordance with examples as described herein. In some implementations, aspects of the operations of 1110 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication, comprising:
at least one memory; and
at least one processor coupled with the at least one memory and configured to cause the apparatus to:
transmit, to a first device, a first configuration for transmitting a sensing signal to a target area; and
transmit, to a second device, a second configuration for reflecting a set of incident waves to a set of sensing devices based at least in part on the second configuration.

2. The apparatus of claim 1, wherein:
the apparatus comprises a first user equipment (UE) or a first network entity;
the first device comprises a second UE or a second network entity;
the second device comprises a reconfigurable intelligent surface (RIS) entity comprising a RIS controller or a set of RIS entities, or both; and
the set of sensing devices comprises a set of UEs or a set of network entities, or both.

3. The apparatus of claim 1, wherein the at least one processor is further configured to cause the apparatus to:
transmit the first configuration to the set of sensing devices; and
transmit a third configuration to the set of sensing devices,
wherein the third configuration includes a configuration of a sensing measurement based on the sensing signal having the first configuration.

4. The apparatus of claim 1, wherein the first configuration includes:
a waveform type of a set of waveform-defining parameters associated with the sensing signal;
a set of resources over which the sensing signal is transmitted;
a transmission beam or radiation pattern over which the sensing signal is transmitted;
a transmit power over which the sensing signal is transmitted; or
a sequence generation and physical resource mapping type based on which the sensing signal is generated.

5. The apparatus of claim 1, wherein the second configuration includes:
a mapping of incident angles for the one or more incident waves to reflection angles for the reflections of the one or more incident waves to the set of sensing devices;
a time pattern associated to mappings of incident angles to reflection angles; or
a combination thereof.

6. (canceled)

7. The apparatus of claim 5, wherein the second configuration further includes:
one or more reflection rules, including:
an indication of at least one incident angle or incident angular segment towards the second device and at least one reflection angle or reflection angular segment from the second device such that there is no incident wave reflection towards the at least one reflection angle/angular segment from outside of the incident angle/angular segments;
an indication of at least one incident angle or incident angular segment towards the second device and at least one reflection angle or reflection angular segment from the second device such that there is no incident wave reflection towards the at least one reflection angle/angular segment from the incident angle/angular segments;
an indication of one or more time patterns associated with the one or more reflection rules;
an indication of one or more leakage levels for the second device; or combinations thereof.

8. The apparatus of claim 5, wherein the second configuration further includes:
one or more reflection rules, including:
an indication of at least one incident angle or incident angular segment towards the second device and at least one reflection angle or reflection angular segment from the second device such that there is no incident wave reflection towards the angle outside of the at least one reflection angle or reflection angular segment from the incident angle or incident angular segments;
an indication of at least one incident angle or incident angular segment towards the second device and at least one reflection angle or reflection angular segment from the second device such that there is no incident wave reflection towards the reflection angle outside of the least one reflection angle or reflection angular segment from the incident angles outside of the incident angle or incident angular segments;
an indication of one or more time patterns associated with the one or more reflection rules;
an indication of one or more leakage levels for the second device; or combinations thereof.

9. The apparatus of claim 5, wherein the mapping of incident angles for the set of incident waves to reflection angles for the reflections of the set of incident waves to the set of sensing devices includes an indication of one or more desired energy levels.

10. The apparatus of claim 5, wherein the second configuration is based, at least in part, on:
channel strength indicators (CSIs) for a line-of-sight (LOS) propagation path from the second device to the set of sensing devices;
CSIs for a non-line-of-sight (NLOS) propagation path from the second device to the set of sensing devices;
CSIs for a LOS propagation path from the second device to the first device;
CSIs for an NLOS propagation path from the second device to the first device; or combinations thereof.

11. The apparatus of claim 5, wherein the mapping of incident angles for the one or more incident waves at the second device to reflection angles for the reflections of the one or more incident waves is according to:
one or more mappings of transmission time symbols or transmission beams/angles of the first device to indicated angles of reflection or angular segments of reflection at the second device;
one or more mappings of reception time symbols, the set of one or multiple sensing devices, the reception angle or angular segment of arrival at the set of sensing devices, or a combination thereof, to indicated angles of incidence or angular segments of incidence at the second device; or
a combination thereof.

12. The apparatus of claim 11, wherein the one or more mappings of reception time symbols, the set of one or multiple sensing devices, the reception angle or angular segment of arrival at the set of sensing devices, or a combination thereof, to indicated angles of incidence or angular segments of incidence at the second device includes:
an individual mapping of reception time symbols, the set of sensing devices, the reception angle or angular segment of arrival at the set of sensing devices, or a combination thereof, to indicated angles of incidence or angular segments of incidence at the second device; and
a simultaneous mapping of the reception time symbols, the set of sensing devices, the reception beam, angle or angular segment of arrival at the set of sensing devices, or a combination thereof, to one or more single indicated angles of incidence or angular segments of incidence at the second device;
a simultaneous mapping of multiple of reception time symbols, sensing devices, the reception beams, angle or angular segments of arrival at the set of sensing devices, or a combination thereof, to indicated angles of incidence or angular segments of incidence at the second device; or
a combination thereof.

13. The apparatus of claim 11, wherein the one or more mappings of transmission time symbols, the transmission beams/angles or angular segments of departure at the first device, or a combination thereof, to indicated angles of reflection or angular segments of reflection at the second device includes:
an individual mapping of transmission time symbols, the transmission angle or angular segment of departure at the first device, or a combination thereof, to indicated angles of reflection or angular segments of reflection at the second device; and
a simultaneous mapping of transmission time symbols, the transmission angle or angular segment of departure at the first device, or a combination thereof, to plurality of indicated angles of reflection or angular segments of reflection at the second device;
a simultaneous mapping of multiple of transmission time symbols, the transmission angle or angular segment of departure at the first device, or a combination thereof, to indicated angles of reflection or angular segments of reflection at the second device; or
a combination thereof.

14. The apparatus of claim 5, wherein the second configuration is indicated by:
a 1-D array of binary values;
a 2-D matrix of binary values;
a bitmap;
a 2-D matrix of real positive values; or
a quantized or compressed version of the 1-D array, the 2-D matrices, or the bitmap.

15. The apparatus of claim 1, wherein the at least one processor is further configured to cause the apparatus to:
transmit a fourth configuration to the set of sensing devices, including, for each sensing device of the set of sensing devices:
a determination of one or multiple angle or angular segment of incidence at the second device;
a determination of an angle or angular segment of reflection for each sensing signal transmitted to the second device;
an indication of one or more angles of reception at the set of sensing devices;
an indication of a mapping of reception time symbols, the set of one or multiple sensing devices, the reception angle or angular segment of arrival at the set of sensing devices, or a combination thereof, to indicated angles of incidence or angular segments of incidence at the second device;
an indication of mapping of transmission time symbols and/or transmission beams/angles of the first device to indicated angles of reflection or angular segments of reflection at the second device
an indication of one or more angles or angular segments of incidence for the second device or one or more angles or angular segments of reflection for the second device with respect to an angle or angular segment of incidence for each wave of the set of incident waves received by the second device;
an indication of one or more time patterns with respect to the one or more angles or angular segments of incidence for the second device or one or more angles or angular segments of reflection for the second device;
a location of the first device;
a location of the second device;
an indication of one or more information types to be generated in response to sensing measurements performed by the set of sensing devices;
an indication of one or more quality of service (QOS) parameters for the one or more information types;
an indication of conditions that determine the one or more information types or one or more QoS parameters; or
combinations thereof.

16. The apparatus of claim 1, wherein the at least one processor is further configured to cause the apparatus to:
receive a radio sensing task,
wherein the radio sensing task includes:
information identifying the target area in a coordinate system format available to the first device;
information identifying features of an object of interest to be sensed within the target area; or
information identifying a quality of service (QOS) for sensing;
receive, from the second device capability information for the second device;
receive radio sensing capability information for the apparatus;
determine a radio sensing scenario;
determine the first configuration or the second configuration; or combinations thereof.

17. The apparatus of claim 1, wherein the apparatus is a sensing controller that is part of a network entity, a user equipment (UE), a repeater device, or a core network device.

18. A reconfigurable intelligent surface (RIS) controller associated with a RIS, the RIS controller comprising:
at least one memory; and
at least one processor coupled with the at least one memory and configured to cause the RIS controller to:
receive a configuration associated with reflecting one or more sensing signals reflected by the RIS from a transmitting device; and
adjust RIS reflection characteristics of the RIS based on the received configuration.

19. A system for wireless communication, comprising:
a sensing controller device that transmits a signal configuration for a sensing signal to a transmitting device and transmits a reflection configuration to a reconfigurable intelligent surface (RIS),
wherein the RIS is configured to reflect the sensing signal to a sensing device; and
a RIS controller that adjusts RIS reflection characteristics of the RIS based on the received reflection configuration.

20. A processor for wireless communication, comprising:
at least one controller coupled with at least one memory and configured to cause the processor to:
transmit, to a first device, a first configuration for transmitting a sensing signal to a target area; and
transmit, to a second device, a second configuration for reflecting a set of incident waves to a set of sensing devices based at least in part on the second configuration.

21. The processor of claim 20, wherein the at least one controller is further configured to cause the processor to:
transmit the first configuration to the set of sensing devices; and
transmit a third configuration to the set of sensing devices,
wherein the third configuration includes a configuration of a sensing measurement based on the sensing signal having the first configuration.
